(19) United States
(12) Patent Application Publication
(10) Pub. No.: US 2026/0231098 A1
(43) Pub. Date: Aug. 6, 2026

(54) SYSTEMS AND METHODS FOR IMPROVED POSITIONING

(71) Applicant: Telefonaktiebolaget LM Ericsson (PUBL), Stockholm (SE)

(72) Inventors: Atieh RAJABI KHAMESI, Newark, CA (US); Jung-Fu CHENG, FREMONT, CA (US); Julien FORGEAT, San Jose, CA (US)

(21) Appl. No.: 19/154,430

(22) PCT Filed: Feb. 9, 2024
(86) PCT No.: PCT/SE2024/050116

§ 371 Date: Aug. 7, 2025

Related U.S. Application Data
(60) Provisional application No. 63/444,718, filed on Feb. 10, 2023.

(51) Int. Cl. H04W 64/00

(52) U.S. Cl. CPC H04W 64/00

(57) ABSTRACT

A method (1700) by a user equipment, UE (1012), for improved UE positioning is provided. The method includes the UE performing (1702) positioning computation to obtain a first UE position estimate based on a first set of positioning related reports. Based on a respective compatibility score for each positioning related report in the first set of positioning related reports, the UE identifies (1704) a second set of positioning related reports. The second set of positioning related reports is a subset of the first set of positioning related reports. The UE determines (1706) whether the second set of positioning related reports is smaller than the first set of positioning related reports. When the second set of positioning related reports is smaller than the first set of positioning related reports, the UE performs (1708) positioning computation to obtain a second UE position estimate based on the second set of positioning related reports.

### TECHNICAL FIELD

The present disclosure relates, in general, to wireless communications and, more particularly, systems and methods for improved positioning.

### BACKGROUND

User Equipment (UE) positioning is the core of location-based services and has a variety of commercial applications such as, for example, entertainment, healthcare, geo-targeting advertisement, smart factories, and smart warehouses. With the advent of eXtended Reality (XR), UE positioning become more important. The requirement for positioning accuracy varies among the different applications. For example, the requirement for positioning accuracy for industrial applications may be from a centimeter level, while the requirement for emergency calls may be to a few meters accuracy.

In 3GPP TS 36.305, a list of positioning techniques are provided. A few representative methods are described below:
Enhanced Cell Identifier (ID): This technique uses the cellular network's knowledge of information relating to the serving cell of the UE (i.e., cell ID and other information) to determine the position.
Assisted Global Navigation Satellite System (GNSS): The UE retrieves GNSS information to determine its position.
Observed Time Difference of Arrival (OTDOA): Using this technique, the UE estimates the time difference of reference signals from different base stations and reports this information to the network for multilateration.
Uplink Time Difference of Arrival (UTDOA): This technique uses the received signals from the UE at multiple known positions (e.g., gNBs) to estimate the relative Timing of Arrival (TOA) at different Transmit/Receive Points (TRPs) and then performs the multilateration computation at the network side to obtain an estimated UE position.

Current signal processing techniques can generally be applied by the UE, BS, or TRP to generate positioning related reports in operating environments with enough line-of-sight (LoS) links. To proceed, the ToA is used as the main example. With the known speed of the radio wave, the ToA estimates can be converted to 3D distance estimates between the Transmit/Transmission/Transmitter (TX) and Receive/Reception/Receiver (RX) nodes.

In a radio environment, a transmitted signal may travel directly from the transmitter to the receiver resulting in a LoS path. However, the transmitted signal can also be reflected or scattered by the environment resulting in multiple non-line-of-sight (NLoS) paths. For example, FIG. 1 illustrates a multipath radio environment between a UE and two TRPs. For TRP A, a LoS path exists between the UE's transmitter and TRP A's receiver. For TRP B, however, only NLoS paths exist between the UE's transmitter and TRP B's receiver because of the blockers in the environment.

For a LoS path, conventional signal processing techniques can be applied to obtained accurate ToA estimates as the timing of the first observed path in the received signal. For these LoS paths, the ToAs represent the correct representation of the 3D distance between the TX and RX, d_{3D}, via the speed of the radio wave, c:

$${ToA}_{LoS} = \frac{{d}_{3 D}}{c}$$

However, for NLoS paths as illustrated in FIG. 1, the radio wave travels indirect path to arrive at the RX via potentially more than one reflection. Hence, the straightforward estimate of the ToA as the first observed path in the received signal will give incorrect estimate of the 3D distance between TX and RX:

$${ToA}_{NLoS} > \frac{{d}_{3 D}}{c}$$

FIGS. 2A and 2B illustrate example magnitudes of LoS and NLoS channel impulse responses (CIRs), respectively. More specifically, Error! Reference source not found.S 2A and 2B illustrate the first observed path ToA, τ_{obs}, as the delay of the first path in the received CIRs for a LoS and a NLoS example in a InF-DH {40%, 2 m, 2 m} radio environment. More specifically, the first observed path ToA for the LoS example illustrated in FIG. 2A may be calculated as:

$$LoS example {τ}_{obs} = {τ}_{dp} = 18.5 taps$$

The first observed path ToA illustrated for the NLoS example illustrated in FIG. 2B may be calculated as:

$$NLoS example {τ}_{obs} = 79.4 > {τ}_{dp} = 30.2 taps$$

Using these over-estimated ToAs or equivalently 3D distances in conventional positioning solutions based on triangulation computation will result in incorrect localization of the UE position.

In addition, AI/ML models can be adopted to infer the correct direct path ToA from the received signals regardless of whether the signals arrive via LoS or NLoS paths:

$${ToA}_{DP} {=}^{Δ} \frac{{d}_{3 D}}{c}$$

That is, the direct path ToA is the time for the radio wave to travel directly from the TX to the RX and ignores any potential blockers in between.

There currently exist certain challenge(s), however. For example, traditional positioning methods and techniques rely on positioning related reports for LoS links provided either by the radio network nodes or the UEs using conventional signal processing methods and techniques. With advanced machine learning models, positioning related reports can also be generated for NLoS links. However, the multitude of positioning related reports can have different accuracy or reliability. Blindly using all reports provided by either conventional signal processing or advance machine learning approaches can result in less accurate UE positions.

### SUMMARY

Certain aspects of the disclosure and their embodiments may provide solutions to these or other challenges. For example, methods and systems provide improved positioning by using an initial position estimate based on a first set of positioning related reports to rate the compatibility scores of different positioning related reports and an iterative selection of subsets of positioning related reports with higher confidence levels.

According to certain embodiments, a method by a UE for improved UE positioning includes performing positioning computation to obtain a first UE position estimate based on a first set of positioning related reports. Based on a respective compatibility score for each positioning related report in the first set of positioning related reports, the UE identifies a second set of positioning related reports. The second set of positioning related reports is a subset of the first set of positioning related reports. The UE determines whether the second set of positioning related reports is smaller than the first set of positioning related reports. When the second set of positioning related reports is smaller than the first set of positioning related reports, the UE performs positioning computation to obtain a second UE position estimate based on the second set of positioning related reports.

According to certain embodiments, a UE for improved UE positioning is configured to perform positioning computation to obtain a first UE position estimate based on a first set of positioning related reports. Based on a respective compatibility score for each positioning related report in the first set of positioning related reports, the UE is configured to identify a second set of positioning related reports. The second set of positioning related reports is a subset of the first set of positioning related reports. The UE is configured to determine whether the second set of positioning related reports is smaller than the first set of positioning related reports. When the second set of positioning related reports is smaller than the first set of positioning related reports, the UE is configured to perform positioning computation to obtain a second UE position estimate based on the second set of positioning related reports.

According to certain embodiments, a method by a network node for improved UE positioning includes performing positioning computation to obtain a first UE position estimate based on a first set of positioning related reports. Based on a respective compatibility score for each positioning related report in the first set of positioning related reports, the network node identifies a second set of positioning related reports. The second set of positioning related reports is a subset of the first set of positioning related reports. The network node determines whether the second set of positioning related reports is smaller than the first set of positioning related reports. When the second set of positioning related reports is smaller than the first set of positioning related reports, the network node performs positioning computation to obtain a second UE position estimate based on the second set of positioning related reports.

According to certain embodiments, a network node for improved UE positioning is configured to perform positioning computation to obtain a first UE position estimate based on a first set of positioning related reports. Based on a respective compatibility score for each positioning related report in the first set of positioning related reports, the network node is configured to identify a second set of positioning related reports. The second set of positioning related reports is a subset of the first set of positioning related reports. The network node is configured to determine whether the second set of positioning related reports is smaller than the first set of positioning related reports. When the second set of positioning related reports is smaller than the first set of positioning related reports, the network node is configured to perform positioning computation to obtain a second UE position estimate based on the second set of positioning related reports.

Certain embodiments may provide one or more of the following technical advantage(s). For example, certain embodiments may provide a technical advantage of improving UE position estimation accuracy when positioning related reports are provided either by the radio network nodes or the UEs are of different accuracy or quality.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a multipath radio environment between a UE and two TRPs;

FIGS. 2A and 2B illustrate example magnitudes of LoS and NLoS channel impulse responses (CIRs), respectively;

FIG. 3 illustrates an example method performed by the position generation entity, according to certain embodiments;

FIG. 4 illustrates an example iterative method performed by the position generation entity, according to certain embodiments;

FIG. 5 illustrates an example of ideal trilateration in a 2D space, according to certain embodiments;

FIG. 6 illustrates an example of trilateration with inaccurate positioning reports, according to certain embodiments;

FIG. 7 illustrates an example of a 3GPP indoor factory (InF) model with, according a particular embodiment;

FIG. 8 illustrates an example plot of 90%-tile of 2D positioning error versus estimated ToA cutoff in an indoor factory scenario where the UE transmit power is 23 dBm, according to a particular embodiment;

FIG. 9 illustrates an example plot 700 of 90%-tile of 2D positioning error versus estimated ToA threshold in an indoor factory scenario where the UE transmit power is 13 dBm, according to a particular embodiment;

FIG. 10 illustrates an example plot 800 of 90%-tile of 2D positioning error versus estimated ToA threshold in an indoor factory scenario where the UE transmit power is 3 dBm, according to a particular embodiment;

FIG. 11 illustrates an example plot 900 demonstrating the performance and robustness of an alternative of constructing the second set of position related reports, according to a particular embodiment;

FIG. 12 illustrates an example communication system, according to certain embodiments;

FIG. 13 illustrates an example UE, according to certain embodiments;

FIG. 14 illustrates an example network node, according to certain embodiments;

FIG. 15 illustrates a block diagram of a host, according to certain embodiments;

FIG. 16 illustrates a virtualization environment in which functions implemented by some embodiments may be virtualized, according to certain embodiments;

FIG. 17 illustrates a host communicating via a network node with a UE over a partially wireless connection, according to certain embodiments;

FIG. 18 illustrates an example method by a UE and/or network node for improved UE positioning, according to certain embodiments;

FIG. 19 illustrates another example method by a UE for improved UE positioning, according to certain embodiments; and

FIG. 20 illustrates another example method by a network node for improved UE positioning, according to certain embodiments.

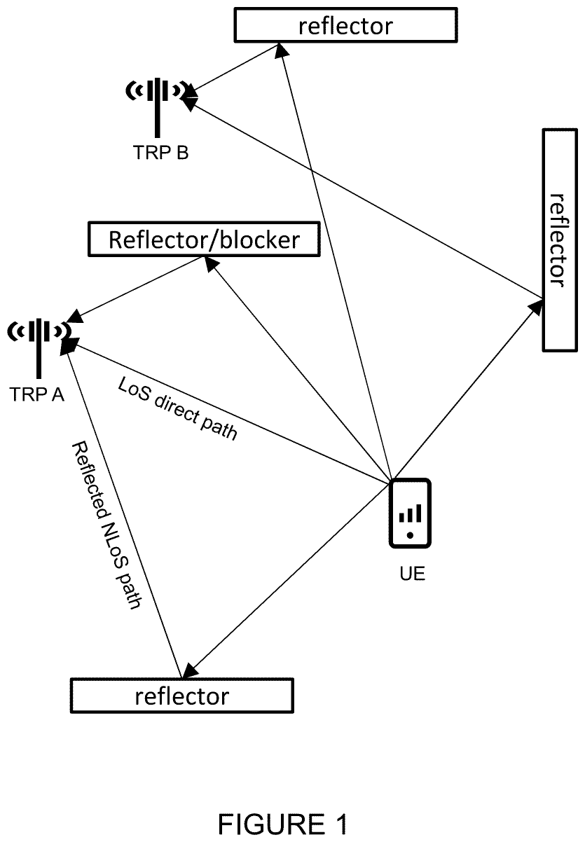

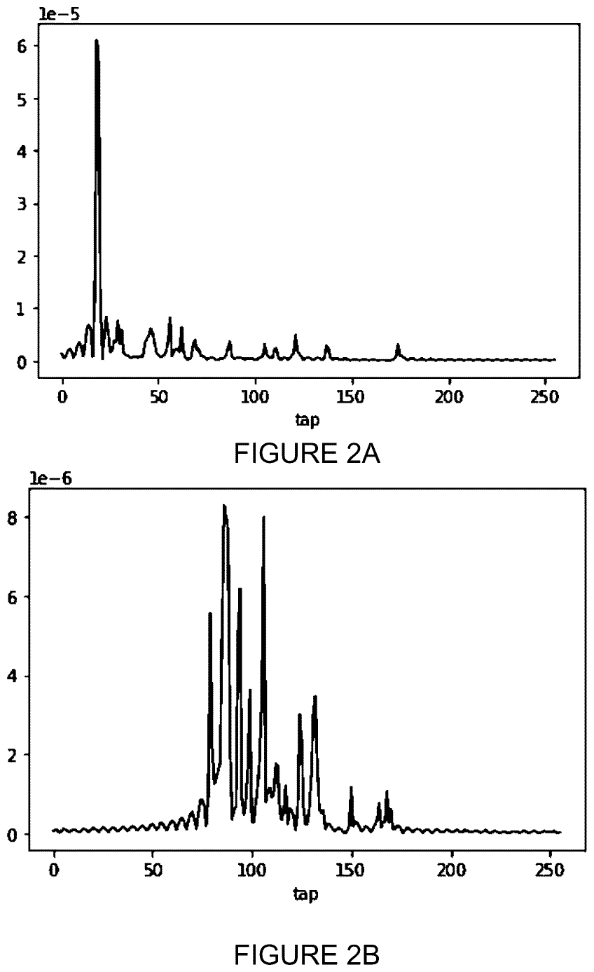

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc. The terms network node and radio network node are used interchangeably herein.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of downlink (DL) physical signals are reference signal (RS) such as Primary Synchronization Signal (PSS), Secondary Synchronization Signal (SSS), Channel State Information-Reference Signal (CSI-RS), Demodulation Reference Signal (DMRS) signals in SS/PBCH block (SSB), discovery reference signal (DRS), Cell Specific Reference Signal (CRS), Positioning Reference Signal (PRS), etc. RS may be periodic. For example, RS occasions carrying one or more RSs may occur with certain periodicity (e.g., 20 ms, 40 ms, etc.). The RS may also be aperiodic.

Each SSB carries New Radio-Primary Synchronization Signal (NR-PSS), New Radio-Secondary Synchronization Signal (NR-SSS) and New Radio-Physical Broadcast Channel (NR-PBCH) in four successive symbols. One or multiple Synchronization Signal Blocks (SSBs) are transmitted in one SSB burst which is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's SFN) etc. Therefore, SMTC occasion may also occur with certain periodicity (e.g., 5 ms, 10 ms, 20 ms, 40 ms, 80 ms, and 160 ms). Examples of uplink (UL) physical signals are reference signals such as Sounding Reference Signals (SRS), Demodulation Reference Signals (DMRS), etc. The term physical channel refers to any channel carrying higher layer information e.g. data, control etc. Examples of physical channels are Physical Broadcast Channel (PBCH), Physical Downlink Control Channel (PDCCH), Physical Downlink Shared Channel (PDSCH), Physical Uplink Shared Channel (PUSCH), Physical Uplink Control Channel (PUCCH), Physical Uplink Shared Channel (PUSCH), Short PUSCH (sPUCCH), Short PDSCH (sPDSCH), Short PUCCH (sPUCCH), Short PUSCH (sPUSCH), MTC PDCCH (MPDCCH), Narrowband PBCH (NPBCH), Narrowband PDCCH (NPDCCH), Narrowband PDSCH (NPDSCH), Narrowband PUSCH (NPUSCH), Enhanced PDCCH (E-PDCCH), etc.

The term time resource used herein may correspond to any type of physical resource or radio resource expressed in terms of length of time. Examples of time resources are symbol, time slot, subframe, radio frame, transmission time interval (TTI), interleaving time, slot, sub-slot, mini-slot, system frame number (SFN) cycle, hyper-SFN (H-SFN) cycle, etc.

A multitude of positioning related reports are provided to the position generation entity by at least one positioning related report generation entity. Herein, general positioning related reports may include at least one of the following:
ToA of a DL signal or an UL signal,
TDoA of DL signals or UL signals such as, for example, DL reference signal time difference (DL RSTD), and UL Relative Time of Arrival (T_{UL-RTOA}),
Timing Advance (T_{ADV}),
DL or UL angle of departure (AoD),
DL or UL angle of arrival (AoA),
Reference signal received power (RSRP) such as, for example, DL-Positioning Reference Signal-Reference Signal Received Power (DL PRS-RSRP), and UL-Sounding Reference Signal-Reference Signal Received Power (UL SRS-RSRP),
Reference Signal Received Path Power (RSRPP) such as, for example, DL-PRS-Reference Signal Received Path Power (DL PRS-RSRPP) and UL-SRS-Reference Signal Received Path Power (UL SRS-RSRPP),
Cell ID and TRP related information (e.g., Reference Signal (RS) resource and/or resource set ID),
Carrier phase difference, and/or
Round-trip time (RTT) measurement, which is obtained by combining gNB Rx-Tx time difference and UE Rx-Tx time difference.

According to certain embodiments, two broad positioning scenarios are considered in the examples described below. In a first positioning scenario, which may be referred to as a network-based scenario, it is assumed that the positioning related reports are generated by a UE, a BS, or a TRP. These positioning related reports are reported to a centralized node in the network for determining the UE's position. For example, according to certain embodiments, the network configures the UE to transmit UL SRS and configures more than one TRP to receive the SRS signals. Each of the TRPs process the received signals to generate reports that can be used by the network to determine the UE position. As another example, according to certain embodiments, the UE receives DL PRS from a set of TRPs. The UE processes these received signals to generate reports that can be used by the network to determine the UE location.

In a second positioning scenario, which may be referred to as a UE-based scenario, the positioning related reports are generated by a UE. These positioning related reports are further utilized by the UE to determine its own location. For example, according to certain embodiments, the UE receives DL PRS from a set of TRPs. The UE processes these received signals to generate reports that can be further used by the UE to determine the UE's own location.

Current signal processing techniques are generally applied by the UE, BS, or TRP to generate positioning related reports in operating environments with LoS links. In certain embodiments described below, ToA is used as the main example. With the known speed of the radio wave, the ToA estimates can be converted to 3D distance estimates between the Transmit/Transmission/Transmitter (TX) and Receive/Reception/Receiver (RX) nodes. However, the methods, systems, and embodiments described herein are not limited to timing-based reports. Rather, the methods, systems and embodiments are applicable to any of the other positioning related reports such as, for example, received power measurements or angle measurements.

Herein, the term “positioning generation entity” refers to the entity or node that is responsible for making the positioning calculation of the target UE. It may be noted that while the term “positioning related report” is used, it is intended to cover both the first case where the positioning related report generation entity is different from the positioning generation entity, and the second case where positioning related report generation entity is also the positioning generation entity.

For the first case (i.e., the positioning related report generation entity is different from the positioning generation entity), a positioning related report containing measurement is explicitly formulated and sent from a measurement entity to the positioning generation entity. In network based-positioning scenario described above, said position generation entity is normally residing in the location management function (LMF). In this scenario, a positioning related report generation entity can a BS or a TRP. For instance, according to certain embodiments, the network configures the UE to transmit UL SRS and configures more than one TRP to receive the SRS signals. Each of the TRPs processes the received signals to generate reports that can be used by the network to determine the UE position.

In the UE-assisted positing scenario described above, a positioning related report generation entity is a UE. For instance, the UE receives DL PRS from a set of TRPs. The UE processes these received signals to generate reports that can be used by the network to determine the UE location. Thus, in a UE-based position scenario, such positioning related reports are generated by a UE and further used by said UE to determine its own positions.

For the second case (i.e., the positioning related report generation entity is the same as the positioning generation entity), the positioning related report containing measurement does not need to be sent from one entity to another entity, and it is up to implementation as to how the concept of positioning related report is realized (either implicitly or explicitly).

The multitude of positioning related reports provided to the positioning generation entity is referred to as the first set of positioning related reports.

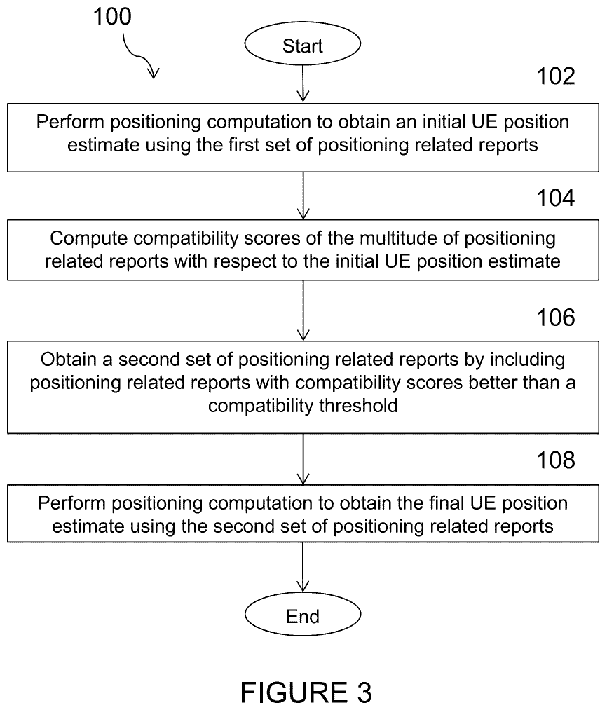

FIG. 3 illustrates an example method 100 performed by the position generation entity, according to certain embodiments. As depicted in FIG. 3, the position generation entity may perform may one or more of the following steps:
Step 102—Perform positioning computation to obtain an initial UE position estimate using the first set of positioning related reports.
Step 104—Compute compatibility scores of the multitude of positioning related reports with respect to the initial UE position estimate.
Step 106—Obtain a second set of positioning related reports by including positioning related reports with compatibility scores better than a compatibility threshold. The second set of positioning related reports may partially or fully overlap with the first set of positioning related reports.
Step 108—Perform positioning computation to obtain the final UE position estimate using the second set of positioning related reports.

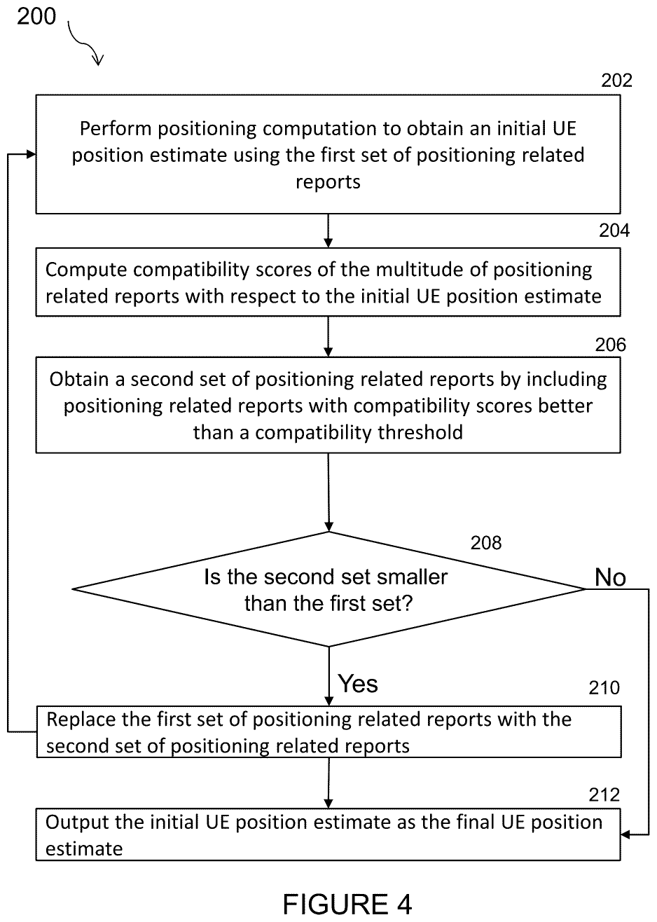

According to certain other embodiments, certain steps can be performed iteratively. FIG. 4 illustrates an example iterative method 200 performed by the position generation entity, according to certain embodiments. As depicted in FIG. 4, the position generation entity may perform one or more of the following steps:
Step 202—Perform positioning computation to obtain an initial UE position estimate using the first set of positioning related reports.
Step 204—Compute compatibility scores of the multitude of positioning related reports with respect to the initial UE position estimate.
Step 206—Obtain a second set of positioning related reports by including positioning related reports with compatibility scores better than a compatibility threshold. The second set of positioning related reports may partially or fully overlap with the first set of positioning related reports.
Step 208—Determine whether the second set of positioning related reports is smaller than the first set of positioning related reports. More specifically, the position generation entity may determine whether the second set of positioning related reports includes fewer reports than the first set of positioning related reports.
   If the second set of positioning related reports is smaller (i.e., fewer) than the first set of positioning related reports, then the method proceeds to step 210. Otherwise, the method proceeds to step 212.
      Specifically, step 210 includes replacing the first set of positioning related reports with the second set of positioning related reports and return to step 202.
      However, if it is determined at step 208 that the second set of positioning related reports is the same as (i.e., not smaller or fewer than) the first set of positioning related reports, the method is stopped and, at step 212, the UE position estimate obtained in step 202 is output as the final UE position estimate.

In any of the above exemplary embodiments, if said second set of positioning related reports obtained in step 106 or step 206 has fewer than a minimum number of positioning related reports, the method is stopped, and the UE position estimate obtained in step 102 or 202, respectively, is output as the final UE position estimate. Said minimum number of positioning related reports depends on at least the type of positioning related reports and the positioning methods and techniques. In one particular embodiments, the minimum number is three if ToA reports are used for 2D positioning. As another particular embodiment, the minimum number is two if TDoA reports are used for 2D positioning. Furthermore, more number of reports may be needed for 3D positioning.

Without losing generality, unless explicitly stated, ToA estimate is used as an example to represent various timing-based metrics, including: relative timing (e.g., UL RTOA), timing difference (e.g., DL RSTD), gNB Rx-Tx time difference, UE Rx-Tx time difference. It is well known that, in real-life deployment, clocks are not accurately synchronized between TRP and UE, and/or between TRPs. Thus, ToA is often converted to other formats of timing metrics to combat the implementation imperfections. However, it should be clear to those skilled in the art that the same methods and techniques disclosed herein can be easily modified to apply to timing-based metrics in general.

The steps described above with regard to FIGS. 3 and 4 are described in more detail below.

### Steps 102/202—Performing Positioning Computation to Obtain an Initial UE Position Estimate Using the First Set of Positioning Related Reports

The process of combining the positioning reports, e.g., ToAs, to locate the UE position using the distances (i.e., instead of angles) between nodes is called trilateration. The distances to at least three known non-collinear network nodes are sufficient to determine the exact 2D UE position.

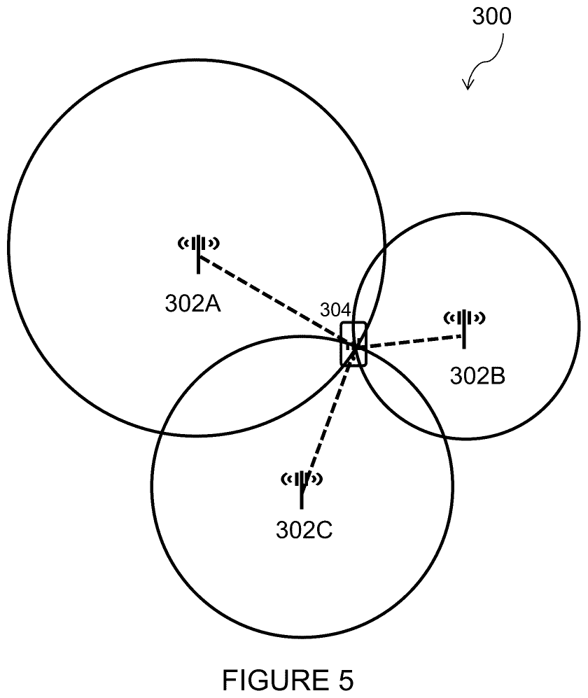

FIG. 5 illustrates an example 300 of ideal trilateration in a 2D space, according to certain embodiments. As shown in FIG. 5, if the positioning related reports are accurate, each TRP 302A, 302B, and 302C is at the center of a circle and the intersection of the circles pinpoints the location of the UE 304. In a 3D space, each TRP is at the center of a sphere, and at least four non-coplanar known network nodes' positions are needed to perform trilateration.

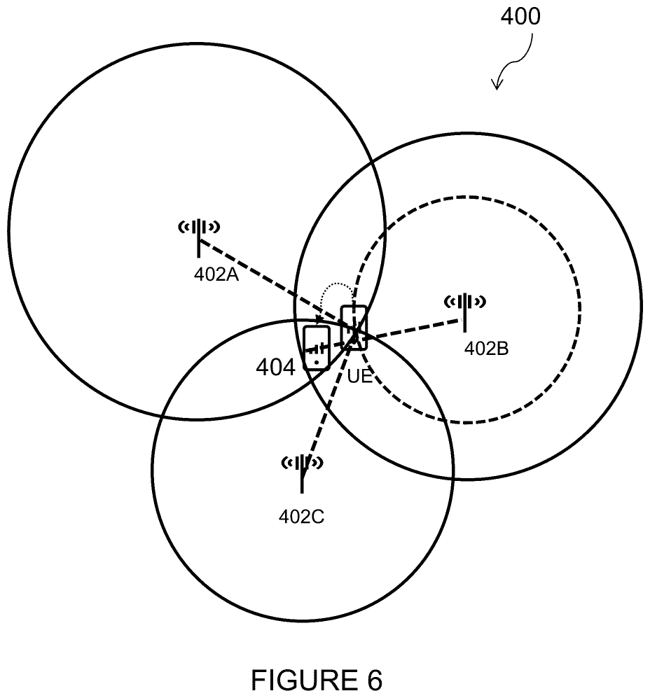

However, in real-world scenario, the estimated distances to the known positions can be inaccurate which result in faulty trilateration. FIG. 6 illustrates one such example 400 of trilateration with inaccurate positioning reports, according to certain embodiments. As shown in FIG. 6, each TRP 402A, 402B, and 402C is at the center of a respective circle. However, though the position of UE 404 would ideally be at the intersection, the actual position of UE 404 is slightly offset is not at the intersection of the circles.

In a particular embodiment, a nonlimiting exemplary implementation of this positioning step is to find the UE position estimate that minimizes the sum of the loss between (a) the distance, d(\hat{p}_{UE},p_{TRP}(i)), between the UE position estimate, \hat{p}_{UE}, and the known position of a TRP, p_{TRP}(i), and (b) the reported distance between the UE 404 and said TRP 402A, 402B, and 402C, \hat{d}(i).

$${\hat{p}}_{UE} = {arg min}_{{p}_{UE}} {\sum }_{i} ℒ ( d ( {p}_{UE} , {p}_{TRP} ( i ) ) , \hat{d} ( i ) )$$

where, L(⋅) can be L1 or L2 loss functions and i is the index of the positioning reports in the set.

L1 loss function, also known as Least Absolute Deviations (LAD), is the sum of the all the absolute differences between the true value, yᵢ, and the predicted value, ŷᵢ.

$$L 1 loss function {=}^{Δ} {\sum }_{i = 1}^{n} \vert {y}_{i} - {\hat{y}}_{i} \vert$$

L2 loss function, also known as Least Square Errors (LS), is the sum of the all the squared differences between the true value, yᵢ, and the predicted value, ŷᵢ.

$$L 2 loss function {=}^{Δ} {\sum }_{i = 1}^{n} {( {y}_{i} - {\hat{y}}_{i} )}^{2}$$

In another particular embodiment, a nonlimiting exemplary implementation of this positioning step is to compensate potential UE timing errors or jitters in the estimated ToA. This is achieved by adding a UE timing error related term to be jointly searched with hypothesized UE position:

$${\hat{p}}_{UE} , {\hat{δ}}_{UE} = {arg min}_{{p}_{UE} , {δ}_{UE}} {\sum }_{i} ℒ ( d ( {p}_{UE} , {p}_{TRP} ( i ) ) - {δ}_{UE} , \hat{d} ( i ) )$$

In still another particular embodiment, a nonlimiting exemplary implementation of this positioning step is to assume that the reported timing measurement is for TDoA instead of ToA, where TDoA(i, r) is obtained from measurements and c×TDoA(i, r) provides \hat{d}(i)−\hat{d}(r), where c is the speed of light. When using such TDoA, the TRPs are assumed to be synchronized. The benefit of TDoA is that clock offset (or clock drift) at the UE cancels out by measuring the difference of (a) ToA between TRP i and the UE, and (b) ToA between the reference TRP r and the UE, i≠r. Then the position of the UE can be estimated by considering the distance differences between (a) the UE positioning and a known TRP with index i and (b) the UE positioning and a reference TRP with index r.

$${\hat{p}}_{UE} = {arg min}_{{p}_{UE}} {\sum }_{i \neq r} ℒ ( d ( {p}_{UE} , {p}_{TRP} ( i ) ) - d ( {p}_{UE} , {p}_{TRP} ( r ) ) , \hat{d} ( i ) - \hat{d} ( r ) )$$

With the various types of loss functions provided above, an optimizer (or optimization algorithm, e.g., gradient descent) can be used to find the best UE position estimation that achieves the minimal value of the loss function. Note that neural network is typically not involved in this step. Thus the loss functions above are not to be confused with the loss function used in the training of neural networks.

Steps 104/204—Compute Compatibility Scores of the Multitude of Positioning Related Reports with Respect to the Initial UE Position Estimate

The compatibility score of the positioning related reports is a function of the estimated UE position, \hat{p}_{UE}, and the deployment knowledge of the known network nodes. Thus, using the UE position estimate obtained in steps 102 and 202, the compatibility scores of positioning related reports are computed at steps 104 and 204, respectively.

In a particular embodiment, a nonlimiting example of said function is the square of the differences between (a) the distance, d(\hat{p}_{UE},p_{TRP}(i)), between the UE position estimate, \hat{p}_{UE}, and the known position of a TRP, p_{TRP}(i), and (b) the reported distance between the UE and said TRP, \hat{d}(i):

$$C S ( i ) {=}^{Δ} {\vert d ( {\hat{p}}_{UE} , {p}_{TRP} ( i ) ) - \hat{d} ( i ) \vert}^{2}$$

In another particular embodiment, a nonlimiting example of said function is the absolute value of the differences between (a) the distance, d(\hat{p}_{UE},p_{TRP}(i)) between the UE position estimate, \hat{p}_{UE}, and the known position of a TRP, p_{TRP}(i), and (b) the reported distance between the UE and said TRP, \hat{d}(i):

$$C S ( i ) {=}^{Δ} \vert d ( {\hat{p}}_{UE} , {p}_{TRP} ( i ) ) - \hat{d} ( i ) \vert$$

When the UE timing error estimate, \hat{δ}_{UE}, is available, yet another nonlimiting example embodiment of said function is the square or the absolute value of the distance differences between (a) the distance, d(\hat{p}_{UE},p_{TRP}(i), between the UE position estimate, \hat{p}_{UE}, and the known position of a TRP, p_{TRP}(i), and (b) the sum of the reported distance between the UE and said TRP, \hat{d}(i), and the UE timing error related estimate:

$$CS ( i ) {=}^{Δ} {\vert d ( {\hat{p}}_{UE} , {p}_{TRP} ( i ) ) - {δ}_{UE} - \hat{d} ( i ) \vert}^{2} or$$

$$CS ( i ) {=}^{Δ} \vert d ( {\hat{p}}_{UE} , {p}_{TRP} ( i ) ) - {δ}_{UE} - \hat{d} ( i ) \vert$$

When the reported timing measurement is for TDoA instead of ToA, a further nonlimiting exemplary embodiment of said function is the square or the absolute value of the distance differences between (a) the UE positioning and a known TRP with index i and (b) the UE positioning and a reference TRP with index r:

$$CS ( i ) {=}^{Δ} {\vert ( d ( {\hat{p}}_{UE} , {p}_{TRP} ( i ) ) - d ( {\hat{p}}_{UE} , {p}_{TRP} ( r ) ) ) - ( \hat{d} ( i ) - \hat{d} ( r ) ) \vert}^{2} or$$

$$CS ( i ) {=}^{Δ} \vert ( d ( {\hat{p}}_{UE} , {p}_{TRP} ( i ) ) - d ( {\hat{p}}_{UE} , {p}_{TRP} ( r ) ) ) - ( \hat{d} ( i ) - \hat{d} ( r ) ) \vert$$

Note, with the known speed of the radio wave, the ToA estimates can be equivalently converted to the 3D distance estimates between the TX and RX nodes. It should be clear to one skilled in the art that the compatibility scores can also be computed based on ToAs.

In yet another particular embodiment, a nonlimiting example of said function includes computing the compatibility scores according to any of the above and ranking the compatibility scores from lowest values to highest values. The ranking order of a positioning related report is defined as the final compatibility score of said positioning related report.

With these nonlimiting exemplary compatibility scores, smaller compatibility scores indicate more compatibility with the UE position estimate \hat{p}_{UE}.

Steps 106/206—Obtain a Second Set of Positioning Related Reports by Including Positioning Related Reports with Compatibility Scores Better than a Compatibility Threshold

According to certain embodiments, in steps 106 and 206 described above, the second set of positioning related reports is constructed by including the positioning related reports from the first set of positioning related reports that have compatibility scores better than a compatibility threshold.

For the nonlimiting exemplary embodiments of compatibility scoring functions provided in the above, a positioning related report is included in the second set of positioning related reports if its compatibility score, CS(i), is smaller than a threshold.

According to certain other embodiments, in steps 106 and 206, the second set of positioning related reports is constructed by taking the M positioning related reports that are most compatible with the UE position estimate \hat{p}_{UE}. As disclosed in steps 104 and 204, the compatibility threshold is the ranking of the compatibility scores.

In a further particular example embodiment of steps 106 and 206, the second set of positioning related reports is constructed by excluding the N positioning related reports that are least compatible with the UE position estimate \hat{p}_{UE} from the first set of positioning related reports. As disclosed in steps 104 and 204, the compatibility threshold is the ranking of the compatibility scores.

### Step 108 and Final Performance of Step 202—Perform Positioning Computation to Obtain the Final UE Position Estimate Using the Second Set of Positioning Related Reports

The basic positioning computation method is the same as that used in step 102 and the initial performance of step 202 except that the second set of positioning related reports is used as the input at step 108 and a second iteration of step 202, respectively.

### Determining Compatibility Score Thresholds

In a particular embodiment, the compatibility score threshold is determined from the distribution of the compatibility scores.

In a particular embodiment, the compatibility score threshold is determined from the performance of the improved positioning method disclosed herein with different compatibility score threshold.

In a particular embodiment, the compatibility score threshold is set to different values for different radio environments.

In a particular embodiment, the compatibility score threshold is set to different values for different iterations when the steps of the main embodiment(s) are executed iteratively.

In a particular embodiment, the compatibility score threshold is set to different values when the positioning related reports are provided by different approaches. For instance, the compatibility score threshold may be set to a different value when the positioning related reports are provided by advanced machine learning models than when the positioning related reports are provided by conventional signal processing methods and techniques.

In a particular embodiment, the compatibility score threshold is set to different values when the positioning related reports are provided by different advanced machine learning models. For instance, the compatibility score threshold may be set to a different value when the positioning related reports are provided by centralized machine learning models than when the positioning related reports are provided by distributed machine learning models.

In a particular embodiment, the number of included positioning related reports, M, or the number of excluded positioning related reports, N, is determined from the performance of the improved positioning method disclosed herein with different settings of said inclusions or exclusions.

In a particular embodiment, the number of included positioning related reports, M, or the number of excluded positioning related reports, N, is set to different values for different radio environments.

In a particular embodiment, the number of included positioning related reports, M, or the number of excluded positioning related reports, N, is set to different values when the positioning related reports are provided by different approaches. The number of included positioning related reports, M, or the number of excluded positioning related reports, N, is set to different values when the positioning related reports are provided by different advanced machine learning models.

### Example Demonstration of Utility

According to certain embodiments, the UE may be requested to transmit an UL signal such as, for example, a SRS, using the existing standard NR air-interface. This signal is received by multiple gNBs at known positions.

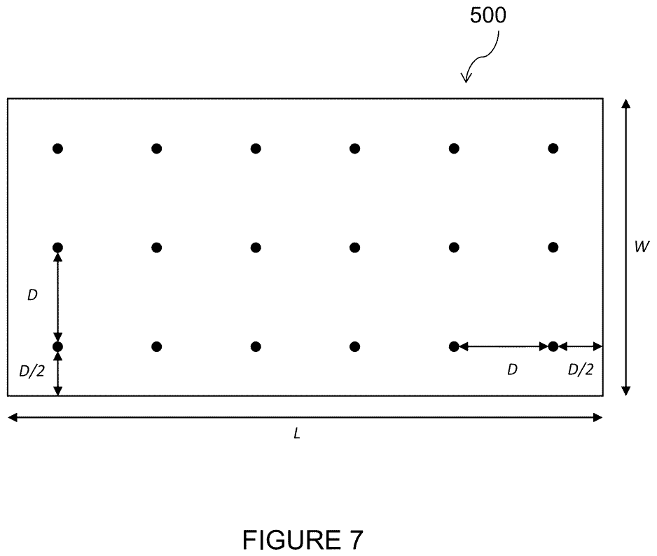

FIG. 7 illustrates as an example 500 of a 3GPP indoor factory (InF) model with, according a particular embodiment. In this scenario, eighteen TRPs are deployed in the factory with TRP locations known at the network. With 60% clutter density and clutter height and width of 6 m and 2 m, respectively, this indoor factory scenario has less than 1% LoS probability from a UE to any TRPs.

For this NLoS environment, distributed deep neural network machine learning models were used to generate the direct path ToAs at different TRPs. Given the different distances from the transmitting UE to the different TRPs, the estimated direct path ToAs have different accuracy levels. A comparison of the cumulative distribution functions of the following two positioning methods and techniques is provided:
Conventional positioning methods (e.g., using only 102 as described with regard to FIG. 3 above) using all eighteen reported direct path ToAs.
Improved positioning methods as described in the steps disclosed above. For this indoor factor environment, the compatibility score threshold was set to 2.3 m. That is, the direct path ToA to a TRP is removed from the first set of positioning related reports if its compatibility score is larger than 2.3 m.

The experiments showed that the UE position can be estimated with an error less than 74 cm in 90% of the time. With the improved methods disclosed herein, the UE positioning error can be reduced to 67 cm in 90% of the time.

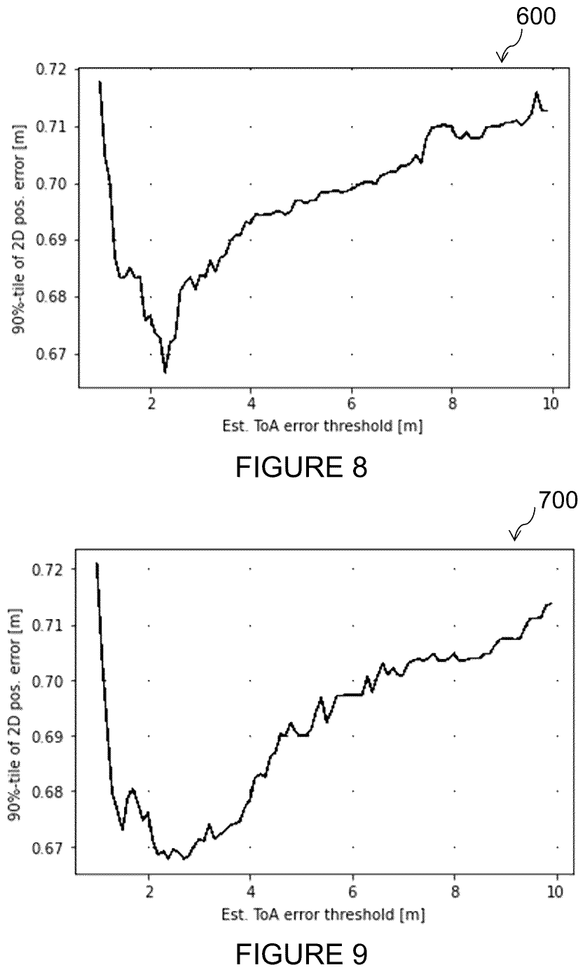

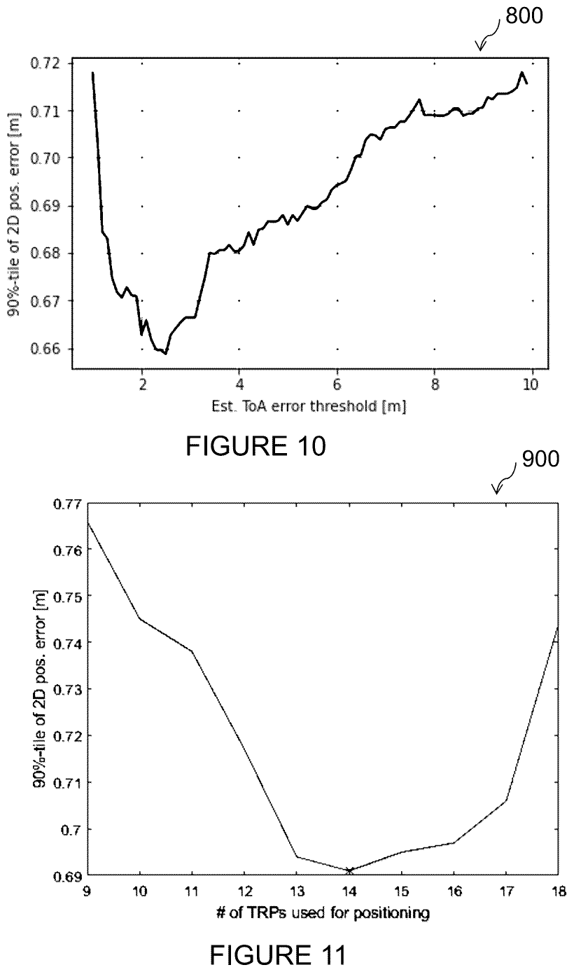

The robustness of the compatibility score threshold is demonstrated in FIG. 8, FIG. 9, and FIG. 10 where the 90%-tile 2D positioning errors are plotted with different UE transmit powers and different compatibility score thresholds. Specifically, FIG. 8 illustrates an example plot 600 of 90%-tile of 2D positioning error versus estimated ToA cutoff in an indoor factory scenario where the UE transmit power is 23 dBm, according to a particular embodiment. FIG. 9 illustrates an example plot 700 of 90%-tile of 2D positioning error versus estimated ToA threshold in an indoor factory scenario where the UE transmit power is 13 dBm, according to a particular embodiment. FIG. 10 illustrates an example plot 800 of 90%-tile of 2D positioning error versus estimated ToA threshold in an indoor factory scenario where the UE transmit power is 3 dBm, according to a particular embodiment.

It can be observed that, with a larger compatibility score threshold setting, the second set of positioning related reports keep more positioning related reports from the first set of positioning related reports. As a result, the accuracy performance of the improved positioning techniques disclosed herein approaches that of conventional positioning techniques. When the compatibility score threshold is set too small, the second set of positioning related reports become much smaller than that of the first set of positioning related reports. Positioning accuracy can be degraded if there are fewer than three positioning related reports left in the second set of positioning related reports.

With a compatibility score threshold around 2.3 m for this indoor factor environment, the improved positioning techniques disclosed herein always achieve better performance than the conventional positioning techniques. There is a band of compatibility score threshold settings that lead to similar level of positioning accuracy improvement. Furthermore, the settings are also robust to the UE transmit powers. That is, the same compatibility score threshold settings can be used with different UE transmit powers.

FIG. 11 illustrates an example plot 900 demonstrating the performance and robustness of an alternative of constructing the second set of position related reports, according to a particular embodiment. As disclosed herein, the second set of position related reports can be constructed by including only a certain number of most compatible reports or excluding a certain number of least compatible reports from the first set. With this approach, it is demonstrated that the UE position error can be reduced to 69 cm in 90% of the time.

FIG. 11 also demonstrates the robustness of the choosing the number of inclusion or exclusion. While keeping 14 achieves the best performance, keeping anywhere between 13 and 16 ToAs results in similar accuracy improvement.

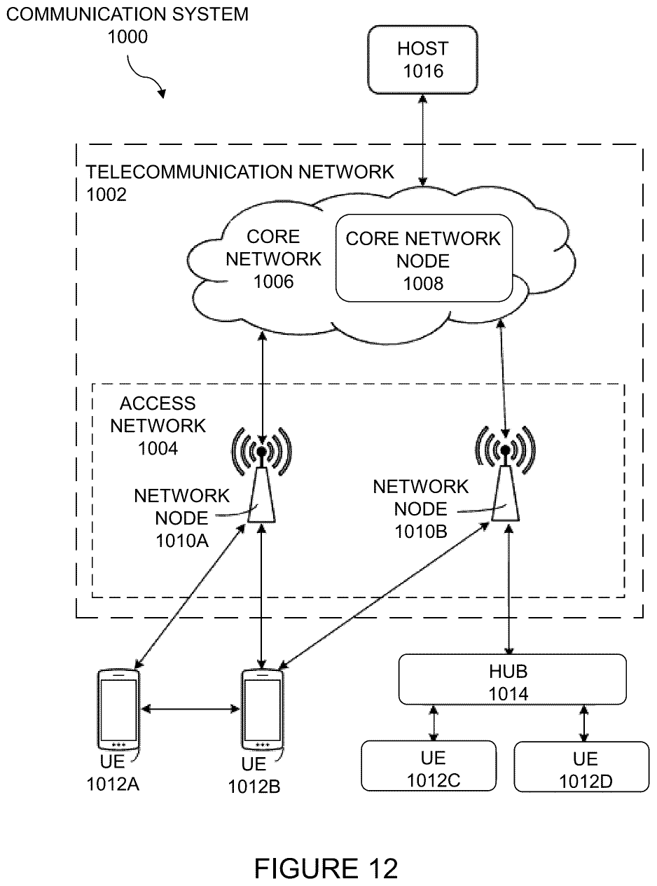

FIG. 12 shows an example of a communication system 1000 in accordance with some embodiments. In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

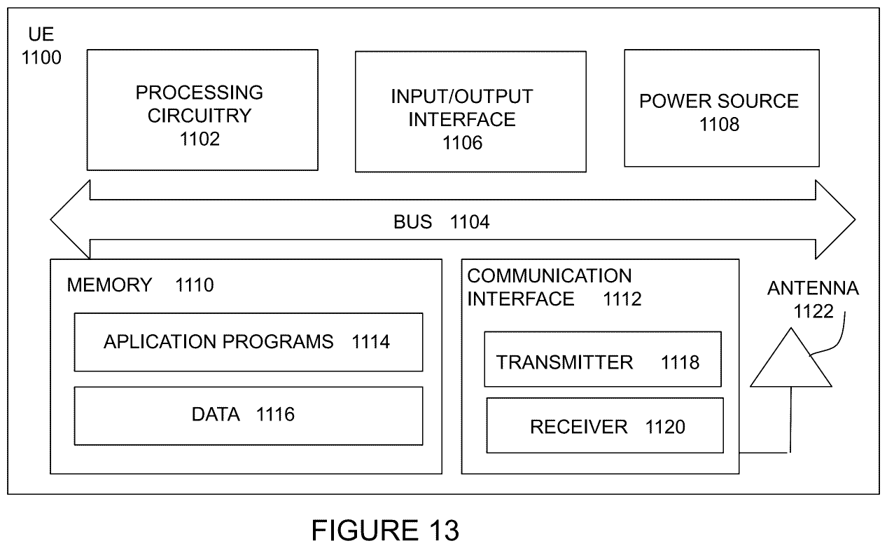

FIG. 13 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

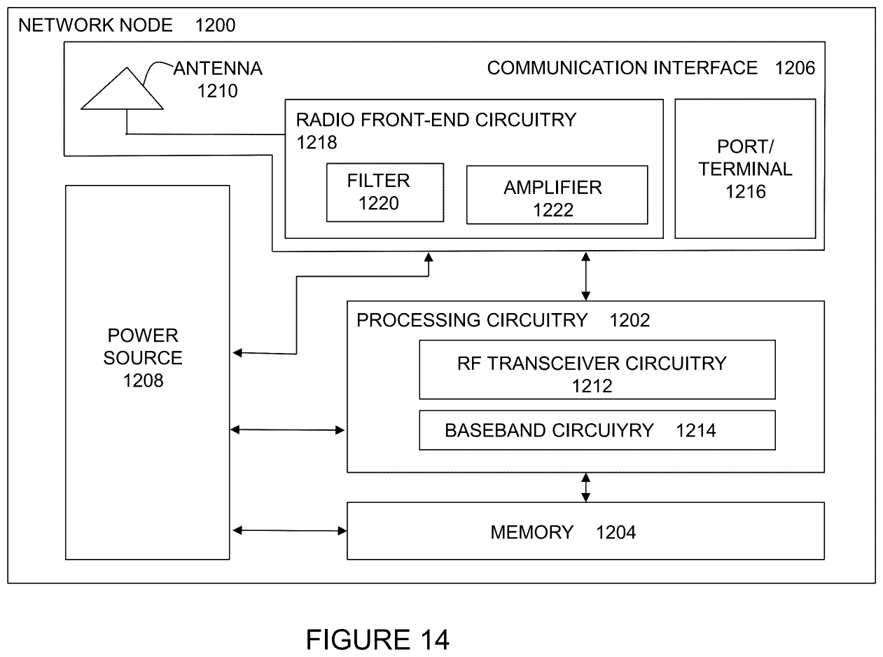

FIG. 14 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 14 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

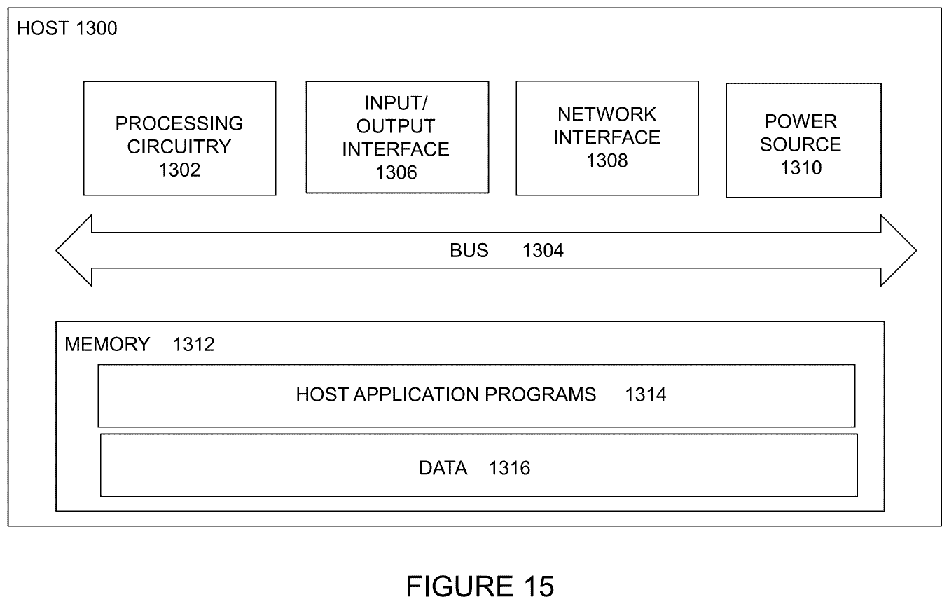

FIG. 15 is a block diagram of a host 1300, which may be an embodiment of the host 1016 of FIG. 12, in accordance with various aspects described herein.

As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

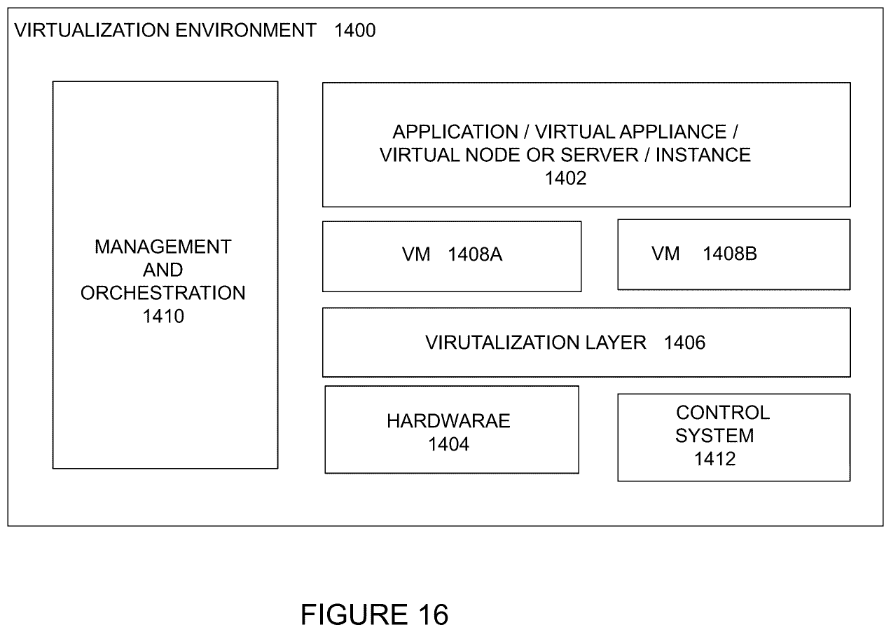

FIG. 16 is a block diagram illustrating a virtualization environment 1400 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

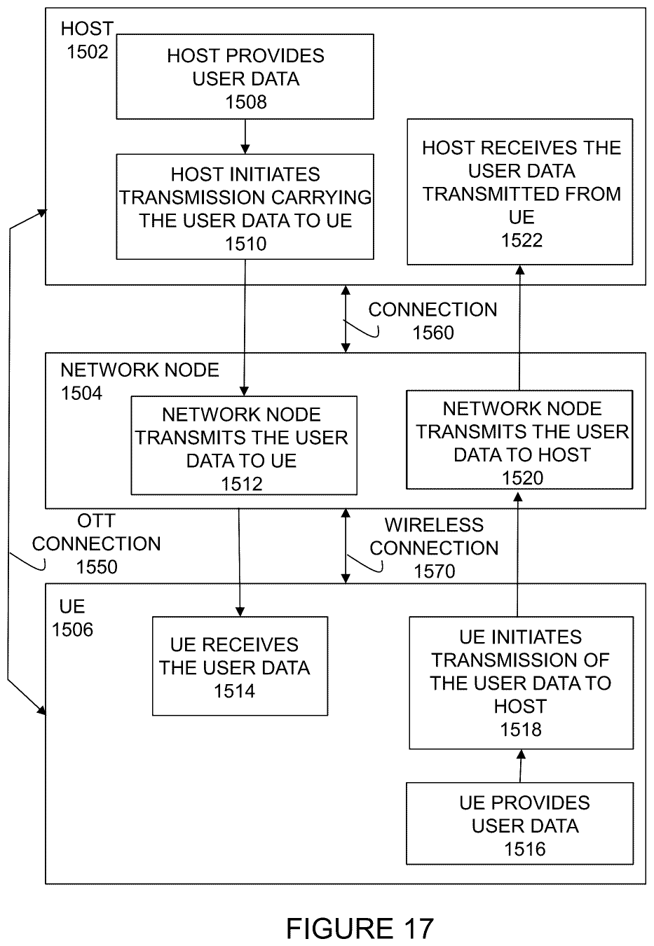

FIG. 17 shows a communication diagram of a host 1502 communicating via a network node 1504 with a UE 1506 over a partially wireless connection in accordance with some embodiments.

Example implementations, in accordance with various embodiments, of the UE (such as a UE 1012a of FIG. 12 and/or UE 1100 of FIG. 13), network node (such as network node 1010a of FIG. 12 and/or network node 1200 of FIG. 14), and host (such as host 1016 of FIG. 12 and/or host 1300 of FIG. 15) discussed in the preceding paragraphs will now be described with reference to FIG. 17.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 12) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

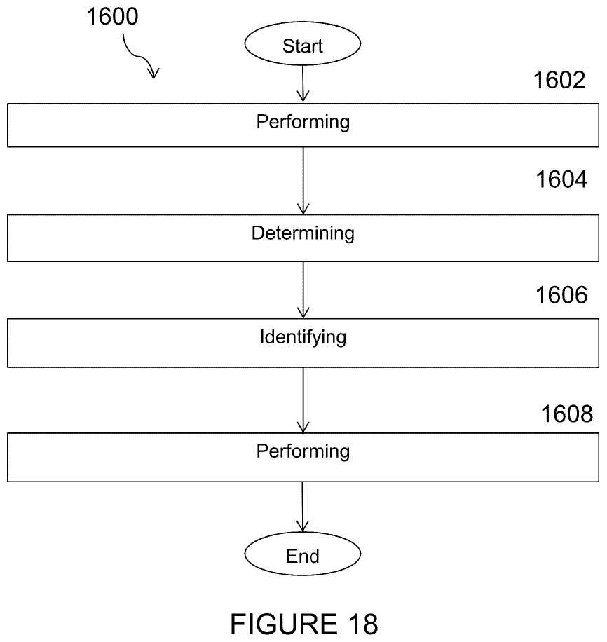

FIG. 18 illustrates an example method 1600 by a UE 1012 and/or network node 1000 for improved UE positioning, according to certain embodiments. In the illustrated embodiment, the method includes a performing step at 1602, a determining step at 1604, a identifying step at 1606, and a performing step at 1608.

For example, at step 1602, based on a first set of positioning related reports, the UE 1012 may perform positioning computation to obtain a first UE position estimate. At step 1604, the UE 1012 may determine a compatibility score for each positioning related report in the first set of positioning related reports. Based on the compatibility scores for each positioning related report in the first set of positioning related reports, the UE 1012 may identify a second set of positioning related reports, at step 1606. Based on the second set of positioning related reports, the UE 1012 may perform positioning computation to obtain a second UE position estimate, at step 1608.

In another example, at step 1602, based on a first set of positioning related reports, the network node 1010 may perform positioning computation to obtain a first UE position estimate. At step 1604, the network node 1010 may determine a compatibility score for each positioning related report in the first set of positioning related reports. Based on the compatibility scores for each positioning related report in the first set of positioning related reports, the network node 1010 may identify a second set of positioning related reports, at step 1606. Based on the second set of positioning related reports, the network node 1010 may perform positioning computation to obtain a second UE position estimate, at step 1608.

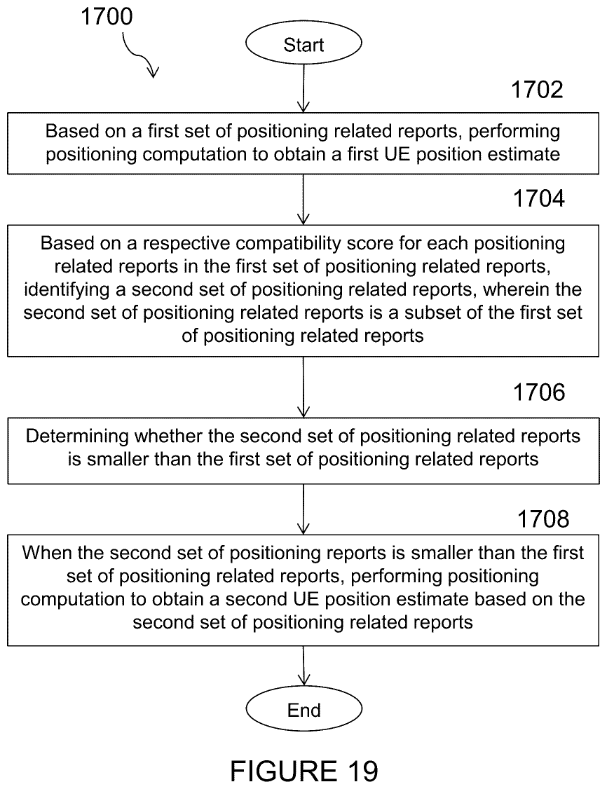

FIG. 19 illustrates another example method 1700 by a UE 1012 for improved UE positioning, according to certain embodiments. As illustrated the method begins at step 102 when the UE 1012 performs positioning, based on a first set of positioning related reports, to obtain a first UE position estimate. Based on a respective compatibility score for each positioning related report in the first set of positioning related reports, the UE 1012 identifies a second set of positioning related reports. The second set of positioning related reports is a subset of the first set of positioning related reports. At step 1706, the UE 1012 determines whether the second set of positioning related reports is smaller than the first set of positioning related reports. When the second set of positioning related reports is smaller than the first set of positioning related reports, the UE 1012 performs positioning computation to obtain a second UE position estimate based on the second set of positioning related reports, at step 1708.

In a particular embodiment, when identifying the second set of positioning related reports based on the respective compatibility score for each positioning related report in the first set of positioning related reports, the UE 1012 compares each compatibility score to a compatibility threshold. The UE 1012 does the comparison for each positioning related report in the first set of positioning related reports. The UE 1012 selects, for the second set of positioning related reports, any positioning related reports that have a compatibility score that is greater than or equal to the compatibility threshold.

In a particular embodiment, the compatibility threshold is determined based on at least one of: a distribution of the compatibility scores for the first set of positioning related reports; a radio environment; a performance of a positioning algorithm; a type of model or algorithm used to generate the first set of positioning related reports; and a number of iterations used to obtain a final UE position estimate.

In a particular embodiment, when identifying the second set of positioning related reports based on the compatibility scores, the UE 1012 determines a ranking for each positioning related report in the first set of positioning related reports based on each respective compatibility score. The ranking for each positioning related report indicates a level compatibility of the positioning related report with the first UE position estimate. Based on the ranking, the UE 1012 selects a number, N, of positioning related reports from the first set of positioning related reports that are least compatible with the first UE position estimate. The UE 1012 excludes the N positioning related reports that are least compatible from the second set of positioning related reports.

In a particular embodiment, when identifying the second set of positioning related reports based on the compatibility scores, the UE 1012 determines a ranking for each positioning related report in the first set of positioning related reports based on each respective compatibility score. The ranking for each positioning related report indicates a level compatibility of the positioning related report with the first UE position estimate. Based on the ranking, the UE 1012 selects a number, M, of positioning related reports from the first set of positioning related reports that are most compatible with the first UE position estimate. The UE 1012 includes the M positioning related reports that are most compatible in the second set of positioning related reports.

In a further particular embodiment, N and/or M are determined based on at least one of a setting associated with a model or algorithm used to generate the first set of positioning related reports; a performance of a model or algorithm used to generate the first set of positioning related reports; a type of a model or algorithm used to generate the first set of positioning related reports; and a radio environment.

In a particular embodiment, the UE 1012 determines that the second set of positioning related reports is less than a minimum number of positioning related reports. When the second set of positioning related reports includes less than the minimum number of positioning related reports, the UE 1012 transmits the first UE position estimate to a network node 1010.

In a particular embodiment, when the second set of positioning related reports is not smaller than the first set of positioning related reports, the UE 1012 outputs the first UE position estimate.

In a particular embodiment, when the second set of positioning related reports is smaller than the first set of positioning related reports, the UE 1012 replaces the first set of positioning related reports with the second set of positioning related reports. The UE 1012 repeats steps 1702-1708 until a final set of positioning related reports is not smaller than a preceding set of positioning related reports. The UE 1012 transmits, to a network node 1010, a final UE position estimate based on positioning computation performed on the final set of positioning related reports.

In a particular embodiment, the UE 1012 determines the compatibility score for each positioning related report in the first set of positioning related reports.

In a further particular embodiment, the compatibility score for each positioning related report in the first set of positioning related reports is determined as a function of the distance between the first UE position estimate and at least one known position of at least one network node.

In a further particular embodiment, the compatibility score for each positioning related report in the first set of positioning related reports is determined as the function of the distance between the first UE position estimate and a first known position of a first network node; and the distance between the first UE position estimate and a second known position of a second network node.

In a particular embodiment, the function of the distance between first UE position estimate and the known position of the at least one network node is a square of a difference between: (a) the distance between the first UE position estimate and the at least one known position of the at least one network node, and (b) a reported distance between the UE and the at least one known position of the at least one network node.

In a particular embodiment, the function of the distance between the first UE position estimate and the known position of the at least one network node is an absolute value of a difference between: (a) the distance between the first UE position estimate and the at least one known position of the at least one network node, and (b) a reported distance between the UE and the at least one known position of the at least one network node.

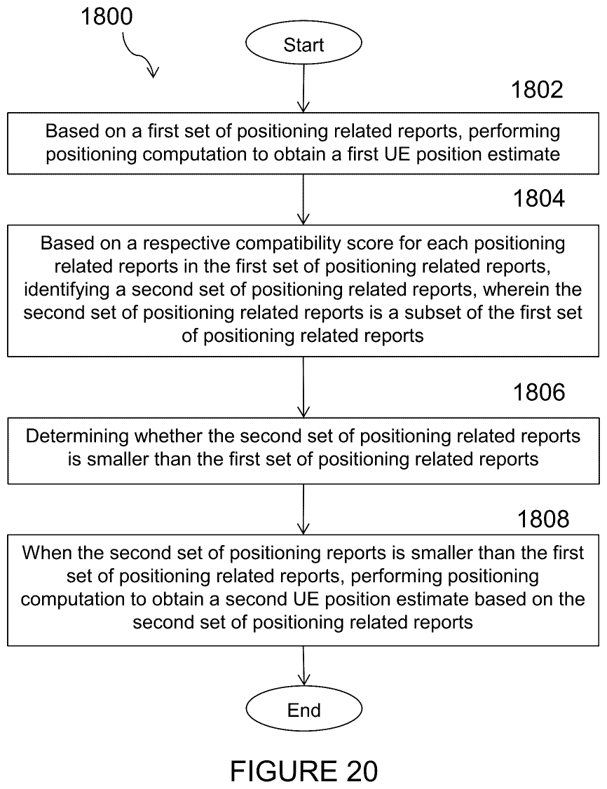

FIG. 20 illustrates another example method 1800 by a network node 1010 for improved UE positioning, according to certain embodiments. As illustrated, the method begins at step 1802 when the network node 1010 performs positioning computation, based on a first set of positioning related reports, to obtain a first UE position estimate. Based on a respective compatibility score for each positioning related report in the first set of positioning related reports, the network node 1010 identifies a second set of positioning related reports, at step 1804. The second set of positioning related reports is a subset of the first set of positioning related reports. At step 1806, the network node 1010 determines whether the second set of positioning related reports is smaller than the first set of positioning related reports. When the second set of positioning related reports is smaller than the first set of positioning related reports, the network node 1010 performs positioning computation to obtain a second UE position estimate based on the second set of positioning related reports, 1808.

In a particular embodiment, the network node 1010 obtains at least a portion of the first set of positioning related reports from at least one other network node.

In a particular embodiment, the at least one other network node comprises at least one base station and/or at least one TRP.

In a particular embodiment, the network node 1010 obtains at least a portion of the first set of positioning related reports from a UE 1012.

In a particular embodiment, when identifying the second set of positioning related reports based on the compatibility scores, the network node 1010 compares an associated compatibility score to a compatibility threshold. The comparison is performed for each positioning related report in the first set of positioning related reports. The network node 1010 selects, for the second set of positioning related reports, any positioning related reports that have a compatibility score that is greater than or equal to the compatibility threshold.

In a particular embodiment, the compatibility threshold is determined based on at least one of: a distribution of the compatibility scores for the first set of positioning related reports; a radio environment; a performance of a positioning algorithm; a type of model or algorithm used to generate the first set of positioning related reports; and a number of iterations used to obtain a final UE position estimate.

In a particular embodiment, when identifying the second set of positioning related reports based on the compatibility scores, the network node 1010 determines a ranking for each positioning related report in the first set of positioning related reports based on each respective compatibility score. The ranking for each positioning related report indicates a level compatibility of the positioning related report with the first UE position estimate. Based on the ranking, the network node 1010 selects a number, N, of positioning related reports from the first set of positioning related reports that are least compatible with the first UE position estimate. The network node 1010 excludes the N positioning related reports that are least compatible from the second set of positioning related reports.

In a particular embodiment, when identifying the second set of positioning related reports based on the compatibility scores, the network node 1010 determines a ranking for each positioning related report in the first set of positioning related reports based on each respective compatibility score. The ranking for each positioning related report indicates a level compatibility of the positioning related report with the first UE position estimate. Based on the ranking, the network node 1010 selects a number, M, of positioning related reports from the first set of positioning related reports that are most compatible with the first UE position estimate. The network node 1010 includes the M positioning related reports that are most compatible in the second set of positioning related reports.

In a particular embodiment, N and/or M are determined based on at least one of: a setting of a model or algorithm used to generate the first set of positioning related reports; a performance of a model or algorithm used to generate the first set of positioning related reports; a type of a model or algorithm used to generate the first set of positioning related reports; and a radio environment.

In a particular embodiment, the network node 1010 determines that the second set of positioning related reports is less than a minimum number of positioning related reports. Based on the second set of positioning related reports being less than the minimum number of positioning related reports, the network node 1010 outputs the first UE position estimate.

In a particular embodiment, when the second set of positioning related reports is not smaller than the first set of positioning related reports, the network node 1010 transmits the first UE position estimate to the UE or another network node.

In a particular embodiment, when the second set of positioning related reports is smaller than the first set of positioning related reports, the network node 1010 replaces the first set of positioning related reports with the second set of positioning related reports. The network node 1010 repeating steps 1802-1808 until a final set of positioning related reports is not smaller than a preceding set of positioning related reports. The network node 1010 transmits, to another network node or the UE, a final UE position estimate based on positioning computation performed on the final set of positioning related reports.

In a particular embodiment, the network node 1010 determines the compatibility score for each positioning related report in the first set of positioning related reports.

In a further particular embodiment, the compatibility score for each positioning related report in the first set of positioning related reports is determined as a function of the distance between the first UE position estimate and at least one known position of at least one network node.

In a further particular embodiment, the compatibility score for each positioning related report in the first set of positioning related reports is determined as the function of the distance between the first UE position estimate and a first known position of a first network node; and the distance between the first UE position estimate and a second known position of a second network node.

In a further particular embodiment, the function of the distance between first UE position estimate and the known position of the at least one network node is a square of a difference between: (a) the distance between the first UE position estimate and the at least one known position of the at least one network node, and (b) a reported distance between the UE and the at least one known position of the at least one network node.

In a further particular embodiment, the function of the distance between the first UE position estimate and the known position of the at least one network node is an absolute value of a difference between: (a) the distance between the first UE position estimate and the at least one known position of the at least one network node, and (b) a reported distance between the UE and the at least one known position of the at least one network node.

In a particular embodiment, the first set of positioning related reports includes at least one value associated with at least one NLoS between the UE and at least one TRP and/or the first set of positioning related reports includes at least one value associated with at least one LoS between the UE and at least one TRP.

In a particular embodiment, the network node is operating as a LMF.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment (UE) for improved UE positioning, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for improved UE positioning, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for improved UE positioning, the method comprising: based on a first set of positioning related reports, performing positioning computation to obtain a first UE position estimate (step 1); determining a compatibility score for each positioning related report in the first set of positioning related reports (step 2); based on the compatibility scores for each positioning related report in the first set of positioning related reports, identifying a second set of positioning related reports (step 3); and based on the second set of positioning related reports, performing positioning computation to obtain a second UE position estimate (step 4).

Example Embodiment C2. The method of Example Embodiment C1, wherein identifying the second set of positioning related reports based on the compatibility scores comprises: for each positioning related report in the first set of positioning related reports, comparing an associated compatibility score to a compatibility threshold, and selecting any positioning related reports that have a compatibility score that is greater than or equal to the compatibility threshold.

Example Embodiment C3. The method of Example Embodiment C2, wherein the compatibility threshold is determined based on at least one of a distribution of the compatibility scores for the first set of positioning related reports; a radio environment; a performance of a positioning algorithm; a type of model or algorithm used to generate the first set of positioning related reports; and a number of iterations used to obtain a final UE position estimate.

Example Embodiment C4. The method of Example Embodiment C1, wherein identifying the second set of positioning related reports based on the compatibility scores comprises: based on each respective compatibility score, determining a ranking for each positioning related report in the first set of positioning related reports, wherein the ranking for each positioning related report indicates a level compatibility of the positioning related report with the first UE position estimate.

Example Embodiment C5. The method of Example Embodiment C4, comprising: based on the ranking, selecting a number, N, of positioning related reports from the first set of positioning related reports that are least compatible with the first UE position estimate; and excluding the N positioning related reports that are least compatible from the second set of positioning related reports.

Example Embodiment C6. The method of Example Embodiment C5, comprising: based on the ranking, selecting a number, M, of positioning related reports from the first set of positioning related reports that are most compatible with the first UE position estimate; and including the M positioning related reports that are most compatible in the second set of positioning related reports.

Example Embodiment C7. The method of any one of Example Embodiments C5 to C6, wherein N and/or M are determined based on at least one of: a setting and/or performance and/or type of a model or algorithm used to generate the first set of positioning related reports; and a radio environment.

Example Embodiment C8. The method of any one of Example Embodiments C1 to C7, wherein the second set of positioning related reports partially overlaps with the first set of positioning related reports.

Example Embodiment C9. The method of any one of Example Embodiments C1 to C7, wherein the second set of positioning related reports full overlaps with the first set of positioning related reports.

Example Embodiment C10. The method of any of one of Example Embodiments C1 to C9, comprising outputting the second UE position estimate.

Example Embodiment C11. The method of any one of Example Embodiments C1 to C9, comprising: determining that the second set of positioning related reports is smaller than the first set of positioning related reports; and based on the second set of positioning related reports being smaller than the first set of positioning related reports, outputting the second UE position estimate.

Example Embodiment C12. The method of any one of Example Embodiments C1 to C9, comprising: determining that the second set of positioning related reports is less than a minimum number of positioning related reports; and based on the second set of positioning related reports being less than the minimum number of positioning related reports, outputting the first UE position estimate.

Example Embodiment C13. The method of Example Embodiment C12, comprising determining the minimum number of positioning related reports based on a type of the first set of positioning related reports.

Example Embodiment C14. The method of Example Embodiment C13, wherein the type of the first set of positioning related reports is associated with 2D positioning or 3D positioning.

Example Embodiment C15. The method of any one of Example Embodiments C1 to C9, comprising: determining that the second set of positioning related reports is not smaller than the first set of positioning related reports; and based on the second set of positioning related reports not being smaller than the first set of positioning related reports, replacing the first set of positioning related reports with the second set of positioning related reports; and repeating steps 1-4 until a final set of positioning related reports is smaller than a preceding set of positioning related reports; and outputting a final UE position estimate based on positioning computation performed on the final set of positioning related reports.

Example Embodiment C16. The method of any one of Example Embodiments C1 to C15, wherein performing positioning computation to obtain the first UE position estimate and/or the second UE position estimate comprises using trilateration.

Example Embodiment C17. The method of any one of Example Embodiment C1 to C16, wherein performing positioning computation to obtain the first UE position estimate and/or the second UE position estimate is based on at least one of one or more ToAs; one or more TDoAs; one or more loss functions; and one or more estimated timing errors and/or jitters.

Example Embodiment C18. The method of any one of Example Embodiments C1 to C17, wherein the compatibility score for each positioning related report in the first set of positioning related reports is determined as a function of the first UE position estimate and a known position of at least one network node.

Example Embodiment C19. The method of any one of Example Embodiments C1 to C18, comprising transmitting, the second UE position estimate and/or a final UE position estimate to a network node.

Example Embodiment C20. The method of any one of Example Embodiments C1 to C19, wherein the first set of positioning related reports comprises at least one value associated with at least one NLoS between the UE and at least one TRP.

Example Embodiment C21. The method of any one of Example Embodiments C1 to C20, wherein the first set of positioning related reports comprises at least one value associated with at least one LoS between the UE and at least one TRP.

Example Embodiment C22. The method of any one of Example Embodiments C1 to C21, further comprising: providing user data; and forwarding the user data to a host via the transmission to the network node.

Example Embodiment C23. A user equipment comprising processing circuitry configured to perform any of the methods of Example Embodiments C1 to C22.

Example Embodiment C24. A user equipment configured to or adapted to perform any of the methods of Example Embodiments C1 to C22.

Example Embodiment C25. A wireless device comprising processing circuitry configured to perform any of the methods of Example Embodiments C1 to C22.

Example Embodiment C26. A computer program comprising instructions which when executed on a computer perform any of the methods of Example Embodiments C1 to C22.

Example Embodiment C27. A computer program product comprising computer program, the computer program comprising instructions which when executed on a computer perform any of the methods of Example Embodiments C1 to C22.

Example Embodiment C28. A non-transitory computer readable medium storing instructions which when executed by a computer perform any of the methods of Example Embodiments C1 to C22.

### Group D Example Embodiments

Example Embodiment D1. A method by a network node for improved UE positioning, the method comprising: based on a first set of positioning related reports, performing positioning computation to obtain a first UE position estimate (step 1); determining a compatibility score for each positioning related report in the first set of positioning related reports (step 2); based on the compatibility scores for each positioning related report in the first set of positioning related reports, identifying a second set of positioning related reports (step 3); and based on the second set of positioning related reports, performing positioning computation to obtain a second UE position estimate (step 4).

Example Embodiment D2. The method of Example Embodiment D1, comprising obtaining the first set of positioning related reports from a plurality of other network nodes.

Example Embodiment D3. The method of Example Embodiment D2, wherein the plurality of other network node comprise at least one base station and/or at least one TRP.

Example Embodiment D4. The method of Example Embodiment D1, comprising obtaining the first set of positioning related reports from a UE.

Example Embodiment D5. The method of any one of Example Embodiments D1 to D4, wherein identifying the second set of positioning related reports based on the compatibility scores comprises: for each positioning related report in the first set of positioning related reports, comparing an associated compatibility score to a compatibility threshold, and selecting any positioning related reports that have a compatibility score that is greater than or equal to the compatibility threshold.

Example Embodiment D6. The method of Example Embodiment D5, wherein the compatibility threshold is determined based on at least one of a distribution of the compatibility scores for the first set of positioning related reports; a radio environment; a performance of a positioning algorithm; a type of model or algorithm used to generate the first set of positioning related reports; and a number of iterations used to obtain a final UE position estimate.

Example Embodiment D7. The method of any one of Example Embodiments D1 to D4, wherein identifying the second set of positioning related reports based on the compatibility scores comprises: based on each respective compatibility score, determining a ranking for each positioning related report in the first set of positioning related reports, wherein the ranking for each positioning related report indicates a level compatibility of the positioning related report with the first UE position estimate.

Example Embodiment D8. The method of Example Embodiment D7, comprising: based on the ranking, selecting a number, N, of positioning related reports from the first set of positioning related reports that are least compatible with the first UE position estimate; and excluding the N positioning related reports that are least compatible from the second set of positioning related reports.

Example Embodiment D9. The method of Example Embodiment D8, comprising: based on the ranking, selecting a number, M of positioning related reports from the first set of positioning related reports that are most compatible with the first UE position estimate; and including the M positioning related reports that are most compatible in the second set of positioning related reports.

Example Embodiment D10. The method of any one of Example Embodiments D8 to D9, wherein N and/or M are determined based on at least one of: a setting and/or performance and/or type of a model or algorithm used to generate the first set of positioning related reports; and a radio environment.

Example Embodiment D11. The method of any one of Example Embodiments D1 to D10, wherein the second set of positioning related reports partially overlaps with the first set of positioning related reports.

Example Embodiment D12. The method of any one of Example Embodiments D1 to D10, wherein the second set of positioning related reports full overlaps with the first set of positioning related reports.

Example Embodiment D13. The method of any of one of Example Embodiments D1 to D12, comprising outputting the second UE position estimate.

Example Embodiment D14. The method of any one of Example Embodiments D1 to D12, comprising: determining that the second set of positioning related reports is smaller than the first set of positioning related reports; and based on the second set of positioning related reports being smaller than the first set of positioning related reports, outputting the second UE position estimate.

Example Embodiment D15. The method of any one of Example Embodiments D1 to D12, comprising: determining that the second set of positioning related reports is less than a minimum number of positioning related reports; and based on the second set of positioning related reports being less than the minimum number of positioning related reports, outputting the first UE position estimate.

Example Embodiment D16. The method of Example Embodiment D15, comprising determining the minimum number of positioning related reports based on a type of the first set of positioning related reports.

Example Embodiment D17. The method of Example Embodiment D16, wherein the type of the first set of positioning related reports is associated with 2D positioning or 3D positioning.

Example Embodiment D18. The method of any one of Example Embodiments D1 to D17, comprising: determining that the second set of positioning related reports is not smaller than the first set of positioning related reports; and based on the second set of positioning related reports not being smaller than the first set of positioning related reports, replacing the first set of positioning related reports with the second set of positioning related reports; and repeating steps 1-4 until a final set of positioning related reports is smaller than a preceding set of positioning related reports; and outputting a final UE position estimate based on positioning computation performed on the final set of positioning related reports.

Example Embodiment D19. The method of any one of Example Embodiments D1 to D18, wherein performing positioning computation to obtain the first UE position estimate and/or the second UE position estimate comprises using trilateration.

Example Embodiment D20. The method of any one of Example Embodiment D1 to D19, wherein performing positioning computation to obtain the first UE position estimate and/or the second UE position estimate is based on at least one of one or more ToAs; one or more TDoAs; one or more loss functions; and one or more estimated timing errors and/or jitters.

Example Embodiment D21. The method of any one of Example Embodiments D1 to D20, wherein the compatibility score for each positioning related report in the first set of positioning related reports is determined as a function of the first UE position estimate and a known position of at least one network node.

Example Embodiment D22. The method of any one of Example Embodiments D1 to D21, comprising transmitting, the second UE position estimate and/or a final UE position estimate to another network node.

Example Embodiment D23. The method of any one of Example Embodiments D1 to D22, comprising transmitting, the second UE position estimate and/or a final UE position estimate to the UE.

Example Embodiment D24. The method of any one of Example Embodiments D1 to D23, wherein the first set of positioning related reports comprises at least one value associated with at least one NLoS between the UE and at least one TRP.

Example Embodiment D25. The method of any one of Example Embodiments D1 to D24, wherein the first set of positioning related reports comprises at least one value associated with at least one LoS between the UE and at least one TRP.

Example Embodiment D26. The method of any one of Example Embodiments D1 to D25, wherein the network node is operating as a LMF.

Example Embodiment D27. The method of any of Example Embodiments D1 to D26, further comprising: obtaining user data; and forwarding the user data to a host or a user equipment.

Example Embodiment D28. A network node comprising processing circuitry configured to perform any of the methods of Example Embodiments D1 to D27.

Example Embodiment D29. A network node configured to perform any of the methods of Example Embodiments D1 to D27.

Example Embodiment D30. A computer program comprising instructions which when executed on a computer perform any of the methods of Example Embodiments D1 to D27.

Example Embodiment D31. A computer program product comprising computer program, the computer program comprising instructions which when executed on a computer perform any of the methods of Example Embodiments D1 to D27.

Example Embodiment D32. A non-transitory computer readable medium storing instructions which when executed by a computer perform any of the methods of Example Embodiments D1 to D27.

### Group E Example Embodiments

Example Embodiment E1. A user equipment (UE) for improved UE positioning, the UE comprising: processing circuitry configured to perform any of the steps of any of the Group A and C Example Embodiments; and power supply circuitry configured to supply power to the processing circuitry.

Example Embodiment E2. A network node for improved UE positioning, the network node comprising: processing circuitry configured to perform any of the steps of any of the Group B and D Example Embodiments; power supply circuitry configured to supply power to the processing circuitry.

Example Embodiment E3. A user equipment (UE) for improved UE positioning, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, for improved UE positioning, the method comprising:
based on a first set of positioning related reports, performing positioning computation to obtain a first UE position estimate;
based on a respective compatibility score for each positioning related report in the first set of positioning related reports, identifying a second set of positioning related reports, wherein the second set of positioning related reports is a subset of the first set of positioning related reports;
determining whether the second set of positioning related reports is smaller than the first set of positioning related reports; and
when the second set of positioning related reports is smaller than the first set of positioning related reports, performing positioning computation to obtain a second UE position estimate based on the second set of positioning related reports.

2. The method of claim 1, wherein identifying the second set of positioning related reports based on the respective compatibility score for each positioning related report in the first set of positioning related reports comprises:
for each positioning related report in the first set of positioning related reports, comparing each compatibility score to a compatibility threshold, and
selecting, for the second set of positioning related reports, any positioning related reports that have a compatibility score that is greater than or equal to the compatibility threshold.

3. The method of claim 2, wherein the compatibility threshold is determined based on at least one of:
a distribution of the compatibility scores for the first set of positioning related reports;
a radio environment;
a performance of a positioning algorithm;
a type of model or algorithm used to generate the first set of positioning related reports; and
a number of iterations used to obtain a final UE position estimate.

4. The method of claim 1, wherein identifying the second set of positioning related reports based on the compatibility scores comprises:
based on each respective compatibility score, determining a ranking for each positioning related report in the first set of positioning related reports, wherein the ranking for each positioning related report indicates a level compatibility of the positioning related report with the first UE position estimate;
based on the ranking, selecting a number, N, of positioning related reports from the first set of positioning related reports that are least compatible with the first UE position estimate; and
excluding the N positioning related reports that are least compatible from the second set of positioning related reports.

5. The method of claim 1, wherein identifying the second set of positioning related reports based on the compatibility scores comprises:
based on each respective compatibility score, determining a ranking for each positioning related report in the first set of positioning related reports, wherein the ranking for each positioning related report indicates a level compatibility of the positioning related report with the first UE position estimate;
based on the ranking, selecting a number, M, of positioning related reports from the first set of positioning related reports that are most compatible with the first UE position estimate; and
including the M positioning related reports that are most compatible in the second set of positioning related reports.

6. The method of claim 4, wherein N and/or Mare determined based on at least one of:
a setting associated with a model or algorithm used to generate the first set of positioning related reports;
a performance of a model or algorithm used to generate the first set of positioning related reports;
a type of a model or algorithm used to generate the first set of positioning related reports; and
a radio environment.

7. The method of claim 1, comprising:
determining that the second set of positioning related reports is less than a minimum number of positioning related reports; and
when the second set of positioning related reports includes less than the minimum number of positioning related reports, transmitting the first UE position estimate to a network node.

8. The method of claim 1, comprising:
when the second set of positioning related reports is not smaller than the first set of positioning related reports, outputting the first UE position estimate.

9. The method of claim 1, comprising:
when the second set of positioning related reports is smaller than the first set of positioning related reports, replacing the first set of positioning related reports with the second set of positioning related reports; and
repeating steps 1702-1708 until a final set of positioning related reports is not smaller than a preceding set of positioning related reports; and
transmitting, to a network node, a final UE position estimate based on positioning computation performed on the final set of positioning related reports.

10. The method of claim 1, comprising determining the compatibility score for each positioning related report in the first set of positioning related reports.

11. The method of claim 10, wherein the compatibility score for each positioning related report in the first set of positioning related reports is determined as a function of the distance between the first UE position estimate and at least one known position of at least one network node.

12. The method of claim 11, wherein the compatibility score for each positioning related report in the first set of positioning related reports is determined as the function of:
the distance between the first UE position estimate and a first known position of a first network node; and
the distance between the first UE position estimate and a second known position of a second network node.

13. The method of claim 11, wherein the function of the distance between first UE position estimate and the known position of the at least one network node is a square of a difference between:
(a) the distance between the first UE position estimate and the at least one known position of the at least one network node, and
(b) a reported distance between the UE and the at least one known position of the at least one network node.

14. The method of claim 11, wherein the function of the distance between the first UE position estimate and the known position of the at least one network node is an absolute value of a difference between:
(a) the distance between the first UE position estimate and the at least one known position of the at least one network node, and
(b) a reported distance between the UE and the at least one known position of the at least one network node.

15. A method by a network node for improved User Equipment, UE, positioning, the method comprising:
based on a first set of positioning related reports, performing positioning computation to obtain a first UE position estimate;
based on a respective compatibility score for each positioning related report in the first set of positioning related reports, identifying a second set of positioning related reports, wherein the second set of positioning related reports is a subset of the first set of positioning related reports;
determining whether the second set of positioning related reports is smaller than the first set of positioning related reports;
when the second set of positioning related reports is smaller than the first set of positioning related reports, performing positioning computation to obtain a second UE position estimate based on the second set of positioning related reports.

16. A user equipment, UE, for improved UE positioning, the UE configured to:
based on a first set of positioning related reports, perform positioning computation to obtain a first UE position estimate;
based on a respective compatibility score for each positioning related report in the first set of positioning related reports, identify a second set of positioning related reports, wherein the second set of positioning related reports is a subset of the first set of positioning related reports; and
determine whether the second set of positioning related reports is smaller than the first set of positioning related reports; and
when the second set of positioning related reports is smaller than the first set of positioning related reports, perform positioning computation to obtain a second UE position estimate based on the second set of positioning related reports.

17-29. (canceled)

30. A network node for improved User Equipment, UE, positioning, the network node configured to:
based on a first set of positioning related reports, perform positioning computation to obtain a first UE position estimate;
based on a respective compatibility score for each positioning related report in the first set of positioning related reports, identify a second set of positioning related reports, wherein the second set of positioning related reports is a subset of the first set of positioning related reports; and
determine whether the second set of positioning related reports is smaller than the first set of positioning related reports; and
when the second set of positioning related reports is smaller than the first set of positioning related reports, perform positioning computation to obtain a second UE position estimate based on the second set of positioning related reports.

31.-32. (canceled)
